(19) United States
(12) Patent Application Publication
(10) Pub. No.: US 2026/0093553 A1
(43) Pub. Date: Apr. 2, 2026

(54) AUTOMATED TASK DELIVERY USING CHECKPOINTING

(71) Applicant: Visa International Service Association, San Francisco, CA (US)

(72) Inventors: Manav Shah, Walkeshwar (IN); Debdeep Bandyopadhyay, Durgapur (IN); Prithwish Banerjee, Bangalore (IN); Ravi Shanker Kumar Sinha, Bengaluru (IN); Neeraj Surana, Bengaluru (IN)

(73) Assignee: Visa International Service Association, San Francisco, CA (US)

(21) Appl. No.: 18/901,523

(22) Filed: Sep. 30, 2024

(51) Int. Cl. G06F 9/50

(52) U.S. Cl. CPC G06F 9/505

(57) ABSTRACT

A computer system automates and balance loads balancing a Highly Available Server (HA server), a plurality of nodes, a final delivery server, a failover mechanism within the HA server, and a methodology for a reinforcement learning model. The HA server maintains a dynamic list of reports, assigns tasks to the nodes based on their availability status, and employs a reinforcement learning-based model to optimize task assignment. The nodes receive and complete assigned tasks from the HA server and sends task outputs back to the HA server. The final delivery server receives processed reports from the HA server. The failover mechanism detects node failures and reassigns tasks among remaining operational nodes. The reinforcement learning model updates its task allocation policy based on the success or failure of completed tasks, maximizes system efficiency, and adjusts the policy to mitigate the impact of system failures.

### TECHNICAL FIELD

The present disclosure is generally directed to techniques for improving the performance of computer systems. More particularly, the present disclosure is directed to reducing computational load of computer systems by increasing the efficiency of the computer systems.

### SUMMARY

An embodiment includes a method for load-balanced delivery of completed tasks to servers. The method includes establishing a message queue at a first server for communication with a plurality of nodes. The first server maintains a list of tasks to be completed and delivered to the nodes. The method includes monitoring the plurality of nodes to determine their availability and assigning tasks to an available node of the plurality of nodes using reinforcement learning. A reward is determined based on a completion status of the assigned task for a current state of the available node. The method includes receiving a completed task from the available node, acknowledging completion of the assigned task by the available node, and delivering the completed task to a second server.

In one aspect of the method, a positive reward is assigned based on a successful completion and delivery of the task by the available node.

In another aspect of the method, which can be combined with one or more previously recited aspects, a negative reward is assigned based on an unsuccessful completion of the task due to node failure.

In another aspect, which can be combined with one or more previously recited aspects, the method includes establishing a policy by learning a strategy over time that maximizes a cumulative reward.

In another aspect, which can be combined with one or more previously recited aspects, the method includes updating the policy dynamically based on the rewards obtained from outcomes of task assignments.

In another aspect of the method, which can be combined with one or more previously recited aspects, the strategy is learned using Q-learning or Deep Q-Networks (DQN).

In another aspect, which can be combined with one or more previously recited aspects, the method includes continuously monitoring activity of each node within a plurality of storage nodes.

In another aspect, which can be combined with one or more previously recited aspects, the method includes detecting that a node has become unavailable, redirecting the task to another available node, and detecting when the unavailable node becomes available and directing a new task thereto.

In another aspect of the method, which can be combined with one or more previously recited aspects, the first server is a highly available (HA) server and the second server is a network-attached storage server.

Another embodiment includes a system for load-balanced delivery of completed tasks to servers. The system includes a highly available (HA) server configured to maintain a message queue in communication with a plurality of nodes and a network-attached storage server configured to communicate with the HA server. The HA server maintains a list of tasks to be completed by at least one of the plurality of nodes and delivered to the network-attached storage server. The HA server is configured to monitor the plurality of nodes and determine the availability of each node and assign tasks to available nodes using reinforcement learning. A reward is determined based on a completion status of the assigned task relative to a current state of the plurality of nodes. The HA server is configured to receive completed tasks from the available nodes, acknowledge completion of tasks by the available nodes, and deliver the completed tasks to the network-attached storage server.

In one aspect of the system, the HA server is configured to assign a positive reward for a successful completion and delivery of tasks.

In another aspect of the system, which can be combined with one or more previously recited aspects, the HA server is configured to assign a negative reward for a unsuccessful completion of tasks due to storage node failure.

In another aspect, which can be combined with one or more previously recited aspects, the system includes a reinforcement learning model to establish a policy by learning a strategy over time to maximize a cumulative reward.

In another aspect of the system, which can be combined with one or more previously recited aspects, the reinforcement learning model is configured to dynamically update the policy based on rewards obtained from outcomes of task assignments.

In another aspect of the system, which can be combined with one or more previously recited aspects, the policy is configured to learn a strategy using Q-learning or Deep Q-Networks (DQN).

In another aspect of the system, which can be combined with one or more previously recited aspects, the HA server is configured to continuously monitor activity of each storage node within a plurality of storage nodes.

In another aspect of the system, which can be combined with one or more previously recited aspects, the HA server is further configured to detect when a storage node becomes unavailable, redirect the task to another available storage node, and detect when the unavailable node becomes available and direct a new task thereto.

Another embodiment includes a method of configuring a failover mechanism in case a node goes down and becomes unavailable. The method includes periodically monitoring, by a highly available (HA) server, a plurality of nodes. The method includes sending, by the HA server, a request to each one of the plurality of nodes to determine the availability of any one of the plurality of nodes. The method includes marking, by the HA server, that a node is unavailable/down when a node fails to respond to the request, or returns an error and redirecting, by the HA server, a load to another node of the plurality of nodes that is an available idle active node when a node is down.

In one aspect, the method includes resuming normal operation of the HA server once the failed node is recovered.

In another aspect, which can be combined with one or more previously recited aspects, the method includes accepting, by the HA server, a processed report as an acknowledgement and preventing, by the HA server, redundancy in report delivery.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The apparatuses, systems, and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates an architecture diagram of a system, according to at least one aspect of the present disclosure.

FIG. 2 is a method of automating delivery of tasks helps reduce the load on servers, according to at least one aspect of the present disclosure.

FIG. 3 is a method of configuring a failover mechanism in case a server goes down, according to at least one aspect of the present disclosure.

FIG. 4 is a block diagram of a computer apparatus with data processing subsystems or components, according to at least one aspect of the present disclosure.

FIG. 5 is a diagrammatic representation of an example computer system that includes a host machine within which a set of instructions to perform any one or more of the methodologies discussed herein may be executed, according to at least one aspect of the present disclosure.

### DESCRIPTION

As used herein a “data center node” refers to an individual computing device or system within a network. It could be a server, but it can also be other devices like routers, switches, or storage systems. A node represents any device that can send, receive, or forward information in a network. While a server can be a node, not all nodes in a data center are servers. A data center is a more general term that includes any network-connected device within the data center.

A “message queue” is a communication method used in software systems to exchange information between different components or applications. It allows one component (the producer) to send messages to a queue, which are then stored until another component (the consumer) retrieves them. This process decouples the sender and receiver, allowing them to operate independently and asynchronously. A message queue may feature asynchronous communication such that producers and consumers don't need to interact with the message queue at the same time. The producer can send a message and move on, while the consumer can retrieve the message whenever it's ready. The message queue may feature decoupling such that components don't need to know about each other's existence. They interact only with the message queue, which simplifies the architecture and allows for more flexibility and scalability. The message queue offers reliability and often ensure that messages are delivered reliably, even if a consumer is temporarily unavailable. They can store messages until the consumer is ready to process them. Message queues offer scalability by allowing multiple producers and consumers, message queues can help balance loads and scale systems horizontally.

As used herein, a NAS (Network Attached Storage) server is a specialized device that provides centralized storage and data management services to a network. It allows multiple users and devices to access and share files over a network, making it an ideal solution for both home and business environments. The NAS server features centralized storage and provides a single location where all files can be stored, managed, and accessed. This centralization simplifies data management and backup. The NAS server features file sharing to support multiple file-sharing protocols like SMB/CIFS, NFS, and AFP, allowing users across different operating systems (Windows, macOS, Linux) to access and share files. The NAS server features data redundancy and protection and many NAS devices support RAID (Redundant Array of Independent Disks) configurations, which provide data redundancy and protection against disk failures. The NAS server often include remote access features, allowing users to access their files from anywhere with an internet connection. The NAS server features scalability such that they can be easily expanded by adding more storage drives or upgrading existing ones, making them suitable for growing storage needs. The NAS server also features backup and recovery for automated backups of other devices on the network, providing a convenient solution for data protection and recovery. Common uses of the NAS server include storing and sharing media files, personal documents, and backups. The NAS server provides centralized file storage, collaboration, data backup, and disaster recovery. NAS media servers provide hosting and streaming media files such as music, videos, and photos.

The term “server” refers to one or more computing devices, which can be standalone or part of a cluster, located in various places and operated by different entities. Servers can be physical or virtual machines that provide services, data, or resources to clients. They may be associated with entities like payment networks or merchants and can handle tasks such as hosting websites, managing databases, or running applications. Servers can also be part of a system, like a point-of-sale system, and may include various hardware and software configurations to service client requests. Servers can refer to different configurations or combinations of processors and devices.

As used herein, the term “system” may refer to one or more computing devices or combinations of computing devices (e.g., processors, servers, client devices, software applications, components of such, and/or the like).

Current automated task delivery techniques suffer from duplicate report delivery and non-failsafe, inefficient report delivery.

In one embodiment, the present disclosure is directed to a system and method to automate task delivery to servers by employing a load balanced automation technique that increases the efficiency of the computing system environment. Automating delivery of tasks helps to reduce the load on the servers.

The load balanced automation techniques employ a Highly Available Server (HA server) that maintains a list of reports to deliver. The HA server assigns tasks to each node based on its availability status using a Reinforcement Learning based model. Once the node completes the task, it sends the output of the task (processed report) to the HA server, which helps train the reinforcement learning model. The HA server then sends the output report to the final delivery server—a network attached storage (NAS) server, which takes care of the delivery.

In one embodiment, the present disclosure is directed to a process for automating task delivery to servers in a load-balanced and efficient manner. According to a process flow, the HA server assigns tasks to each node based on its availability status using a Reinforcement Learning-based model. The HA server maintains a list of reports to deliver and a report processing status at the central system. Once a node completes a task, it sends the output of the task (processed report) to the HA server, which helps train the Reinforcement Learning model. The HA server sends the output report to the final delivery server (NAS), which takes care of the delivery. A failover mechanism is configured in case a server goes down. The HA server periodically checks the availability of each node and redirects the load to another available and idle node if a node is down. The HA server accepts a processed report as an acknowledgement and forwards it to the NAS, ensuring that multiple servers do not deliver a processed report to the same customer multiple times. A reinforcement learning model uses the state, action, and reward to learn the best policy for assigning tasks to nodes and handling failures.

The reinforcement learning model works by defining a state, action, and reward, and then learning the best policy to maximize the reward. The state is defined as the current status of all the nodes, the queue of tasks at the HA server, and the history of node failures. The actions that the HA server can take include assigning a task to a specific node, redirecting the task to another node if the assigned node is down, and receiving the processed report from a node. The reward is defined as the successful completion and delivery of a task. If a task fails due to a node being down, a negative reward or penalty can be given. The policy is the strategy that the HA server learns over time to maximize the reward. The HA server updates its policy based on the rewards it receives from its actions, using techniques like Q-learning or Deep Q-Networks to learn the best policy. In this way, the HA server can learn to efficiently allocate tasks to nodes and handle failures, improving the overall reliability and efficiency of the system.

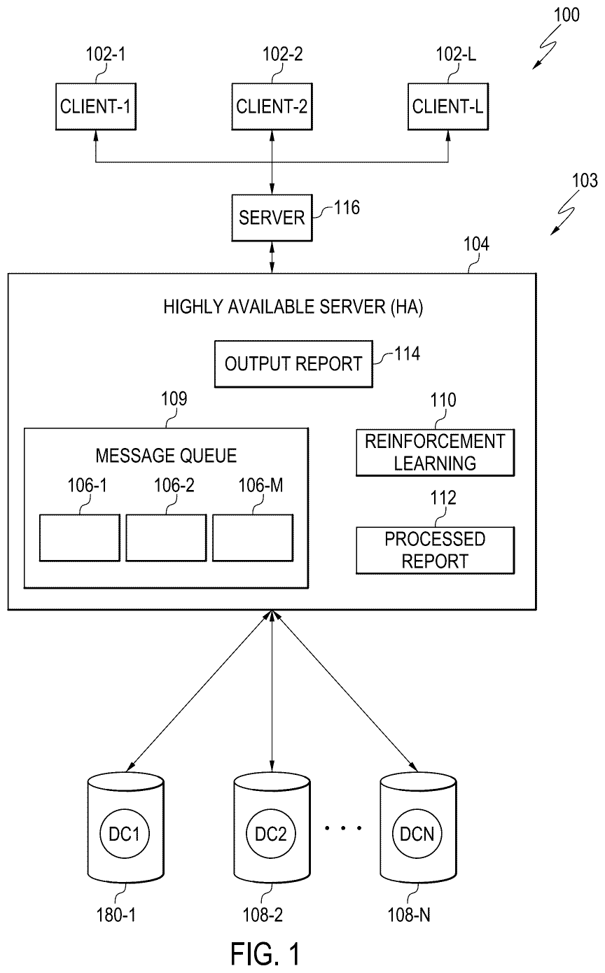

Turning now to figures, FIG. 1 illustrates an architecture of a computer system 100, according to at least one aspect of the present disclosure. The embodiment illustrated in FIG. 1 describes a system 100 for automating delivery of tasks clients 102-1, 102-2, 102-L employing a load balanced automation technique to increase efficiency of the computer system 100 and reduce the load on data center (DC) nodes 108-1, 108-2, 102-N (DC1, DC2, DCN).

Each DC node 108-1, 108-2, 102-N is capable of processing a particular task 106-1, 106-2, 106-M either simultaneously or with some delay. While all the nodes 108-1, 108-2, 102-N in the data centers process the data, redundancy can occur in report delivery. For example, when a first DC node 108-1 (DC1) delivers a processed report 112, a second DC node 108-2 (DC2) may attempt to deliver the same report at a later time, or a third DC node 108-N (DCN) might also do the same subsequently. This results in redundant delivery of the same report by the DC nodes 108-1, 108-2, 102-N (DC1, DC2, DCN), as the report is not unique to any single data center.

In an active-active configuration, for example, all data centers are designed to generate and deliver identical reports. If one data center is unable to handle a task due to overload, it gracefully hands off the task to another data center. At any point, each data center should be fully functional and self-sufficient. Data received by one data center is replicated across the others, ensuring they all work with the same dataset and can generate identical reports. This is a principle of an active-active setup.

A central system 103 comprises a HA server 104 that maintains a message queue 109 of tasks 106-1, 106-2, 106-M to be delivered to the DC nodes 108-1, 108-2, 108-N and also centralizes the management of these reports. The HA server 104 uses an reinforcement learning model 110 to optimize the distribution and delivery of tasks 106-1, 106-2, 106-M to the DC nodes 108-1, 108-2, 108-N. Once a DC node completes a task, it sends the generated report 112 to the HA server 104, which then sends the final report to a delivery server 116, which may be a network-attached storage (NAS) system for delivery to downstream clients 102-1, 102-2, 102-L.

The HA server 104 is responsible for deduplication. When multiple data centers (e.g., DC2 and DC3) send the same report, the HA server 104 identifies and removes duplicate reports, leveraging reinforcement learning model 110 to enhance this deduplication process over time. This ensures that reports 114 are ultimately delivered from a single source—the HA server 104. The deduplication process may vary depending on specific use cases.

The NAS system can be any server type and is not necessarily limited to traditional NAS configurations. The stored reports can be accessed over the internet.

The HA server 104 also implements a failover mechanism. It continuously monitors the availability of each DC node 108-1, 108-2, 108-N, and if a node fails to respond or returns an error, the HA server 104 marks it as unavailable and redirects the load to another active node. When the previously downed node recovers, the HA server 104 resumes normal operations, including assigning it any remaining tasks in the message queue 109.

The reinforcement learning model 110 used by the HA server 104 takes various state variables and makes decisions about task assignment. Based on the outcomes, which could be either successful or failed task completions, the model assigns rewards or penalties to update its policy. This historical data includes metrics such as success rates, failure instances, and processing times. The reinforcement learning model 110 learns to assign tasks to the most reliable DC nodes 108-1, 108-2, 108-N, avoiding those that are frequently unreliable. However, training this model requires a significant amount of data, including data loaded by human operators.

The HA server 104 employed by the load balanced automation technique maintains a list of reports to deliver. The HA server 104 assigns the tasks 106-1, 106-2, 106-M to each DC node 108-1, 108-2, 108-N based on its availability status using the reinforcement learning model 110. The HA server 104 maintains a list of reports to deliver and a report processing status at a central system 103. Once a DC node 108-1, 108-2, 108-N completes a task, it sends a processed report 112 (the output of the task) to the HA server 104, which helps train the reinforcement learning model 110. The HA server 104 then sends the output report 114 to the delivery server 116 (e.g., a network-attached storage (NAS) server), which delivers the output report to the downstream client 102-1, 102-2, 102-L.

A failover mechanism is configured in case a DC node 108-1, 108-2, 108-N goes down and becomes unavailable. The HA server 104 periodically checks the availability of each DC node 108-1, 108-2, 108-N and redirects the load to another available and idle node if a node is down. The HA server 104 accepts a processed report 112 as an acknowledgement and forwards it to the delivery server 116, ensuring that only the HA server 104, and not multiple servers, deliver the processed report 112 or output report 114 to the same client 102-1, 102-2, 102-L multiple times. The reinforcement learning model 110 uses the state, action, and reward to learn the best policy for assigning the tasks 106-1, 106-2, 106-M to the DC nodes 108-1, 108-2, 108-N and handling failures.

The reinforcement learning model 110 works by defining the state, action, and reward, and then learning the best policy to maximize the reward. The state is defined as the current status of all the DC nodes 108-1, 108-2, 108-N, the message queue 109 of tasks 106-1, 106-2, 106-M at the HA server 104, and the history of node failures. The actions that the HA server 104 can take include assigning a task to a specific node, redirecting the task to another node if the assigned node is down, and receiving the processed report 112 from a node. The reward is defined as the successful completion and delivery of a task 106-1, 106-2, 106-M. If a task fails due to a down or unavailable DC node 108-1, 108-2, 108-N, a negative reward or penalty can be given. The policy is the strategy that the HA server 104 learns over time to maximize the reward. The HA server 104 updates its policy based on the rewards it receives from its actions, using techniques like Q-learning or Deep Q-Networks to learn the best policy. In this way, the HA server 104 can learn to efficiently allocate tasks to nodes and handle failures, improving the overall reliability and efficiency of the computer system 100.

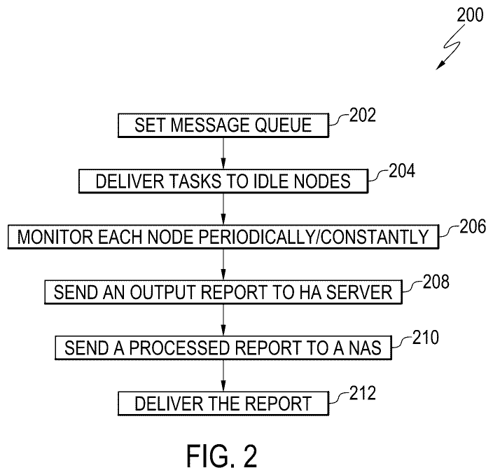

FIG. 2 is a method 200 of automating delivery of tasks helps reduce the load on servers, according to at least one aspect of the present disclosure. With reference to FIG. 2 in conjunction with FIG. 1, according to one embodiment of the method 200, a message queue 109 is set 202 at the HA server 104. Tasks are delivered 204 to idle nodes (using a Q-learning or Deep Q-Networks based model). The HA server 104 monitors 206 each DC node 108-1, 108-2, 108-N constantly. Once an item is processed by a node 108-1, 108-2, 108-N, each node sends 208 an output report to the HA server 104, which serves as an acknowledgement of completion. The HA server 104 sends 210 the processed report112 to the delivery server 106 and ensures there is no duplicate report. The delivery server 116 delivers 212 the report to downstream clients 102-1, 102-2, 102-L.

The method 200 reduces server load by intelligently managing the allocation of tasks to idle nodes, thereby preventing overloading of busy DC nodes 108-1, 108-2, 108-L. The employment of Q-learning or Deep Q-Network models for task delivery ensures optimal decision-making in task distribution, improving server response times and task processing efficiency. Continuous monitoring of DC nodes 108-1, 108-2, 108-N activity by the HA server 104 enhances real-time resource management, contributing to reduced latency and increased system reliability. The forwarding of the processed reports 112 to the delivery server 116 with deduplication checks safeguards against data redundancy, promoting data accuracy and integrity. Completing the delivery of reports from the delivery server 116 ensures timely and secure data handling, essential for maintaining network efficiency and reliability.

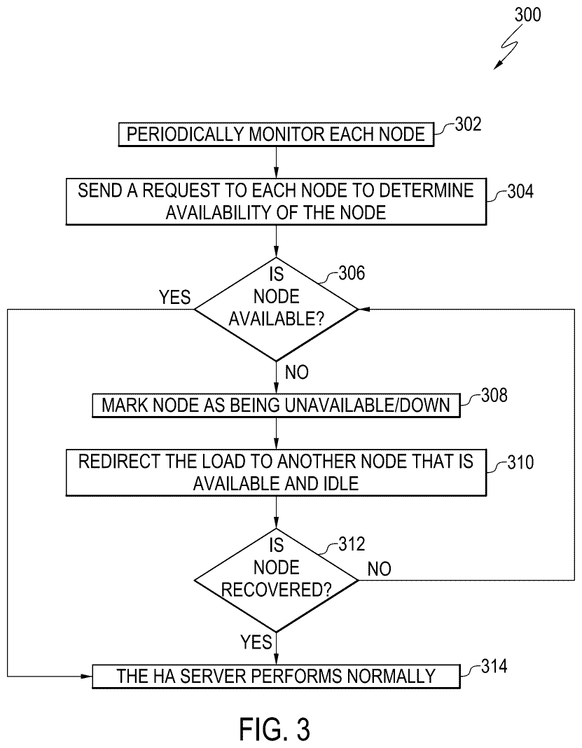

FIG. 3 is a method 300 of configuring a failover mechanism in case a DC node goes down, according to at least one aspect of the present disclosure. The method 300 of configuring a failover mechanism for DC nodes is configured to ensure reliability and continuous operability within a networked environment. With reference to FIG. 3 in conjunction with FIG. 1, according to one embodiment of the method 300, the HA server 104 periodically (e.g., constantly, continuously) monitors 302 each DC node 108-1, 108-2, 108-N and sends 304 a request to each DC node 108-1, 108-2, 108-N to determine 306 its availability. In the event that a DC node 108-1, 108-2, 108-N fails to respond, or returns an error, the HA server 104 marks 308 that node as being unavailable/down. When a DC node 108-1, 108-2, 108-N is down, the HA server 104 redirects 310 the load to another node that is an available idle active node. Once the failed node is recovered 312, the HA server 104 will perform 314 normally. The method 300 ensures server reliability and continuous operability by enabling systematic monitoring, fault detection, dynamic task redirection, and seamless node recovery.

Accepting a processed report 112 as acknowledgement at the HA server 104 and using the HA server 104 to forward the processed report to the delivery server 116 ensures that multiple servers do not deliver a processed report 112 to the same client 102-1, 102-2, 102-L multiple times.

Reinforcement learning 110 comprises several parameters including without limitation state, action, reward, policy, and learning. In this way, the HA server 104 can learn to efficiently allocate tasks 106-1, 106-2, 106-M to the DC nodes 108-1, 108-2, 108-N and handle failures, improving the overall reliability and efficiency of the system 100. The reinforcement learning 110 may require a lot of data and time to train the model and it will mature with time.

The state can be defined as the current status of all the DC nodes 108-1, 108-2, 108-N (idle or busy), the message queue 109 of tasks 106-1, 106-2, 106-M at the HA server 104, and the history of node failures. The state encompasses a server, CPU (central processing unit) load, memory load, network load, normalized load, and/or task load (Low, Medium, High).

The actions that the HA server 104 can take include assigning a task 106-1, 106-2, 106-M to a specific DC node 108-1, 108-2, 108-N, redirecting the task to another DC node if the assigned node is down, and receiving the processed report 112 from the other DC node. The action assigns the output report 114 to the clients 102-1, 102-2, 102-L.

The reward can be defined as the successful completion and delivery of a task 106-1, 106-2, 106-M. If a task 106-1, 106-2, 106-M fails due to a node being down, a negative reward or penalty can be given. A reward of +ve is assigned when the report is completed successfully and delivered and a reward of −ve is assigned when the report failed.

The policy is the strategy that the HA server 104 learns over time to maximize the reward. For example, it might learn to assign tasks 106-1, 106-2, 106-M to the most reliable DC nodes more often, or to avoid assigning tasks to nodes that have recently been down.

Learning includes the HA server 104 updating its policy based on the rewards it receives from its actions. It can use techniques like Q-learning or Deep Q-Networks to learn the best policy.

A Q-table stores Q-values, representing the expected future reward for taking an action in a given state. TABLE 1 is a simplified example of a Q-table.

TABLE 1

| | Action: | Action: | Action: |
|---|---|---|---|
| State | Server A | Server B | Server C |
| (<<20% CPU A, 10% Network CPU A, 50% Memory CPU A, | 1.5 | 1.6 | 1.5 |
| Low Task Load, 30 Normalized Score>>, <<30% CPU B, | | | |
| 10% Network CPU B, 80% Memory CPU B, Medium Task | | | |
| Load, 40 Normalized Score>>, <<30% CPU C, 10% Network | | | |
| CPU C, 80% Memory CPU C, Medium Task Load, 40 | | | |
| Normalized Score>>) | | | |
| (50% CPU A, 10% CPU B, Medium Task Load . . . ) | 0.8 | 1.9 | 1.2 |
| (80% CPU A, 75% CPU B, High Task Load . . . ) | −0.5 | −0.5 | −0.5 |

In the first state, assigning to Server B has a slightly higher Q-value, so the reinforcement learning agent would likely choose that action.

The Q-Table is updated by initialization and experience. During initialization, the Q-values might start at zero or with small random values. For experience, the agent takes an action, observes the environment, receives a reward, and the next state. The Q-Value are updated by adjusting the Q-values (using the Bellman equation, for example) based on the reward, the Q-value of the next state, and a learning rate.

The measurement of server load for balancing purposes can be achieved through various metrics, depending on the specific requirements of the use case. A common approach includes a combination of CPU utilization, memory usage, and network traffic. A normalized load factor can be calculated using the formula:

$$load\_factor = ( alpha * normalized\_cpu ) + ( beta * normalized\_memory ) + ( gamma * normalized\_network )$$

In this equation, alpha, beta, and gamma represent weights assigned based on the relevance of each metric to the use case. The terms normalized_cpu, normalized_memory, and normalized_network denote the normalized values of CPU utilization, memory usage, and network traffic, respectively.

These values can be normalized using the formula:

$$normalized\_metric = ( current\_metric \_value - min\_metric \_value ) / ( max\_metric \_value - min\_metric \_value ) .$$

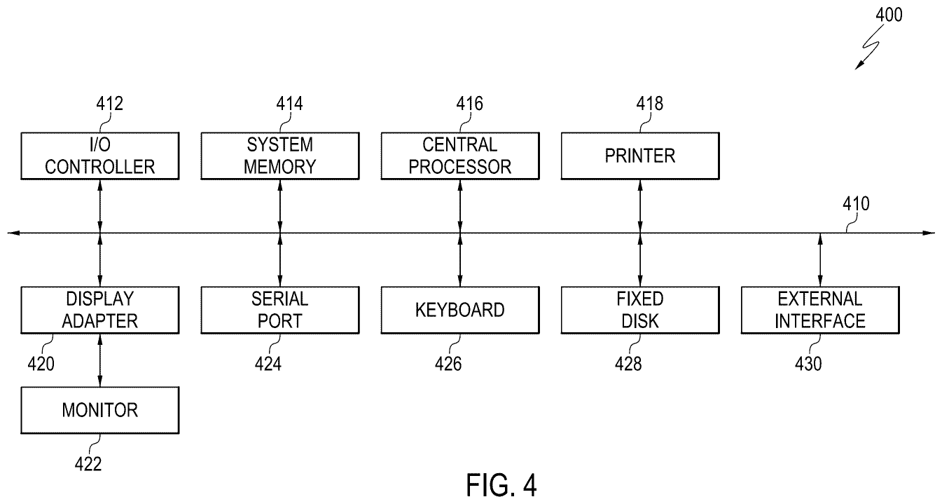

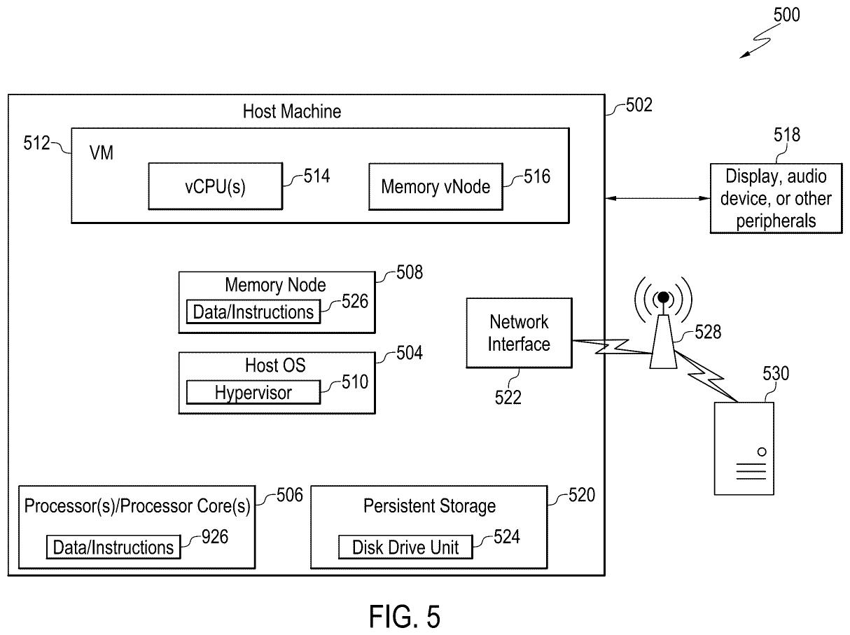

The previously mentioned algorithmic methods 200, 300 depicted and elaborated in FIGS. 2 and 3 can be implemented using the computer apparatus 400, which is depicted in and elaborated on in FIG. 4. Additionally, this computer apparatus 400 may constitute a component of a broader computer system 500, as delineated in FIG. 5. The HA server 104, the delivery server 116, and any servers at the DC nodes 108-1, 108-2, 108-N may be implemented as a computer apparatus 400 shown in FIG. 4 or computer system 500 shown in FIG. 5.

FIG. 4 is a block diagram of a computer apparatus 400 with data processing subsystems or components, according to at least one aspect of the present disclosure. The subsystems shown in FIG. 4 are interconnected via a system bus 410. Additional subsystems such as a printer 418, keyboard 426, fixed disk 428 (or other memory comprising computer readable media), monitor 422, which is coupled to a display adapter 420, and others are shown. Peripherals and input/output (I/O) devices, which couple to an I/O controller 412 (which can be a processor or other suitable controller), can be connected to the computer system by any number of means known in the art, such as a serial port 424. For example, the serial port 424 or external interface 430 can be used to connect the computer apparatus to a wide area network such as the Internet, a mouse input device, or a scanner. The interconnection via system bus allows the central processor 416 to communicate with each subsystem and to control the execution of instructions from system memory 414 or the fixed disk 428, as well as the exchange of information between subsystems. The system memory 414 and/or the fixed disk 428 may embody a computer readable medium.

FIG. 5 is a diagrammatic representation of an example computer system 500 that includes a host machine 502 within which a set of instructions to perform any one or more of the methodologies discussed herein may be executed, according to at least one aspect of the present disclosure. In various aspects, the host machine 502 operates as a standalone device or may be connected (e.g., networked) to other machines. In a networked deployment, the host machine 502 may operate in the capacity of a server or a client machine in a server-client network environment, or as a peer machine in a peer-to-peer (or distributed) network environment. The host machine 502 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 500 includes the host machine 502, running a host operating system (OS) 504 on a processor or multiple processor(s)/processor core(s) 506 (e.g., a central processing unit (CPU), a graphics processing unit (GPU), or both), and various memory nodes 508. The host OS 504 may include a hypervisor 510 which is able to control the functions and/or communicate with a virtual machine (“VM”) 512 running on machine readable media. The VM 512 also may include a virtual CPU or vCPU 514. The memory nodes 508 may be linked or pinned to virtual memory nodes or vNodes 516. When the memory node 508 is linked or pinned to a corresponding vNode 516, then data may be mapped directly from the memory nodes 508 to the corresponding vNode 516.

All the various components shown in host machine 502 may be connected with and to each other or communicate to each other via a bus (not shown) or via other coupling or communication channels or mechanisms. The host machine 502 may further include a video display, audio device or other peripherals 518 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 520 (also referred to as disk drive unit), and a network interface device 522. The host machine 502 may further include a data encryption module (not shown) to encrypt data. The components provided in the host machine 502 are those typically found in computer systems that may be suitable for use with aspects of the present disclosure and are intended to represent a broad category of such computer components that are known in the art. Thus, the system 500 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 524 also may be a Solid-state Drive (SSD), a hard disk drive (HDD) or other includes a computer or machine-readable medium on which is stored one or more sets of instructions and data structures (e.g., data/instructions 526) embodying or utilizing any one or more of the methodologies or functions described herein. The data/instructions 526 also may reside, completely or at least partially, within the main memory node 508 and/or within the processor(s) 506 during execution thereof by the host machine 502. The data/instructions 526 may further be transmitted or received over a network 528 via the network interface device 522 utilizing any one of several well-known transfer protocols (e.g., Hyper Text Transfer Protocol (HTTP)).

The processor(s) 506 and memory nodes 508 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 502 and that causes the host machine 502 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 502, with each server 530 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer-readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer-readable medium, such as RAM, ROM, a magnetic medium such as a hard-drive or a floppy disk, or an optical medium such as a CD-ROM. Any such computer-readable medium may reside on or within a single computational apparatus and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer-readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively, or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively, or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively, or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted being prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method for load-balanced delivery of completed tasks to servers, the method comprising:
establishing a message queue at a first server for communication with a plurality of nodes, wherein the first server maintains a list of tasks to be completed and delivered to the nodes;
monitoring the plurality of nodes to determine their availability;
assigning tasks to an available node of the plurality of nodes using reinforcement learning, wherein a reward is determined based on a completion status of the assigned task for a current state of the available node;
receiving a completed task from the available node;
acknowledging completion of the assigned task by the available node; and
delivering the completed task to a second server.

2. The method of claim 1, wherein a positive reward is assigned based on a successful completion and delivery of the task by the available node.

3. The method of claim 1, wherein a negative reward is assigned based on an unsuccessful completion of the task due to node failure.

4. The method of claim 1, further comprising establishing a policy by learning a strategy over time that maximizes a cumulative reward.

5. The method of claim 4, further comprising updating the policy dynamically based on the rewards obtained from outcomes of task assignments.

6. The method of claim 4, wherein the strategy is learned using Q-learning or Deep Q-Networks (DQN).

7. The method of claim 1, further comprising continuously monitoring activity of each node within a plurality of storage nodes.

8. The method of claim 1, further comprising:
detecting that a node has become unavailable;
redirecting the task to another available node; and
detecting when the unavailable node becomes available and directing a new task thereto.

9. The method of claim 1, wherein the first server is a highly available (HA) server and the second server is a network-attached storage server.

10. A system for load-balanced delivery of completed tasks to servers, the system comprising:
a highly available (HA) server configured to maintain a message queue in communication with a plurality of nodes; and
a network-attached storage server configured to communicate with the HA server, wherein the HA server maintains a list of tasks to be completed by at least one of the plurality of nodes and delivered to the network-attached storage server;
wherein the HA server is configured to:
monitor the plurality of nodes and determine the availability of each node;
assign tasks to available nodes using reinforcement learning, wherein a reward is determined based on a completion status of the assigned task relative to a current state of the plurality of nodes;
receive completed tasks from the available nodes;
acknowledge completion of tasks by the available nodes; and
deliver the completed tasks to the network-attached storage server.

11. The system of claim 10, wherein the HA server is configured to assign a positive reward for a successful completion and delivery of tasks.

12. The system of claim 10, wherein the HA server is configured to assign a negative reward for a unsuccessful completion of tasks due to storage node failure.

13. The system of claim 10, further comprising a reinforcement learning model to establish a policy by learning a strategy over time to maximize a cumulative reward.

14. The system of claim 13, wherein the reinforcement learning model is configured to dynamically update the policy based on rewards obtained from outcomes of task assignments.

15. The system of claim 13, wherein the policy is configured to learn a strategy using Q-learning or Deep Q-Networks (DQN).

16. The system of claim 10, wherein the HA server is configured to continuously monitor activity of each storage node within a plurality of storage nodes.

17. The system of claim 10, wherein the HA server is further configured to:
detect when a storage node becomes unavailable;
redirect the task to another available storage node; and
detect when the unavailable node becomes available and direct a new task thereto.

18. A method of configuring a failover mechanism in case a node goes down and becomes unavailable, the method comprising:
periodically monitoring, by a highly available (HA) server, a plurality of nodes;
sending, by the HA server, a request to each one of the plurality of nodes to determine the availability of any one of the plurality of nodes;
marking, by the HA server, that a node is unavailable/down when a node fails to respond to the request, or returns an error; and
redirecting, by the HA server, a load to another node of the plurality of nodes that is an available idle active node when a node is down.

19. The method of claim 18, comprising resuming normal operation of the HA server once the failed node is recovered.

20. The method of claim 18, comprising:
accepting, by the HA server, a processed report as an acknowledgement; and
preventing, by the HA server, redundancy in report delivery.
